(19) United States
(12) Patent Application Publication
(10) Pub. No.: US 2009/0107515 A1
(43) Pub. Date: Apr. 30, 2009

(54) PROTECTIVE MASK

(76) Inventor: Oren Gavriely, Haifa (IL)

Correspondence Address: YORAM TSIVION, P.O. BOX 1307, PARDES HANNA, 37111, IL

(21) Appl. No.: 11/164,931

(22) PCT Filed: Jun. 7, 2004
(86) PCT No.: PCT/IL2004/000482

§ 371 Date: Dec. 12, 2005

Related U.S. Application Data
(60) Provisional application No. 60/477,029, filed on Jun. 10, 2003.

(51) Int. Cl. A62B 18/08; A62B 18/02; A62B 18/10; A62B 17/04

(52) U.S. Cl. 128/863; 128/201.19; 128/207.12; 2/410

(57) ABSTRACT

An improved respiratory protective mask providing for several novelty features. In some embodiments a sealing member is provided with a skin contacting facet including a multiplicity of protruding ridges. In some embodiments a multi stage valve assembly is provided for blocking of intake of unfiltered ambient air. The valve contains two serially disposed valves defining a cavity. The cavity blocks residual amount of ambient air. In some embodiments a protective hood is provided, made of a modified fabric which enables aeration and dehumidification.

### TECHNICAL FIELD OF THE INVENTION

The present invention relates generally to protective face masks. More specifically the present invention deals with several aspects of protective respiratory face masks.

### BACKGROUND OF THE INVENTION

Airborne hazardous agents are either true gasses or aerosols, containing noxious molecules or microorganisms. They penetrate the human body chiefly via the respiratory tract. The exposure of the upper and lower airways and the lung alveoli to toxic gases cause severe local and systemic reactions that rapidly lead to incapacitation and death. To prevent exposure of the lungs to toxic gases and biological agents, a variety of protective gear and barriers have been developed. In principle these devices include an impermeable shield around the face, the head, or the whole body, and means of supplying fresh and decontaminated air to sustain pulmonary gas exchange. The protective gear currently available may be divided into passive and active categories.

Passive protection refers to gas masks where the flow of air into the mask through the filter is driven by the person's own inspiratory efforts. Active protection refers to masks and other shields where the flow into the breathing circuit is driven by a pump or a blower. Active protection has the distinct advantages of being more effective by preventing penetration of the toxic gases through cracks or incomplete seal between the mask and the skin. This is achieved by maintaining positive pressure inside the shield at all times. Active protection gear is also safer since it assures, at all times, ample supply of fresh air, free of carbon dioxide and rich in oxygen. Additional advantage of active gear is the avoidance of excessive negative pressures needed to generate flow through the filter, especially during strenuous activity, when peak inspiratory flow is elevated.

The disadvantages of active protective gear are their higher cost, its reliance on a power source such as batteries, its increased weight, its susceptibility to breakage and malfunction and its complexity. Of particular concern are the durability and shelf life of the batteries. Another classification of protective gear reflects the seal's location relative to the wearers skin. There are four types of mask seals: 1) the face mask, sealed around the user's face; 2) the nose-mouth mask, sealed only around the respiratory inlets; 3) the hood protective gear sealed around the neck; and 4) the hybrid double seal type including both an external hood or face mask and an inner mouth-nose compartment that sealing the mouth and nose.

The face type gas mask is the standard model used by the military, such as the M40 used by the US army. It covers the mouth, nose and eyes and has a relatively large dead space. The seal of this mask is around the face from the forehead around the maxillae and cheeks down to below the chin. This seal of the facemask must create a snug fit to prevent leakage of toxic gases into the mask. This seal is not applicable for people wearing beards or have unusual facial proportions or deformations. In addition, the facemask requires individual sizing and meticulous adjustment of the pull-straps that hold the mask to the face. A common variant of the facemask, such as disclosed U.S. Pat. No. 6,176,239, includes an additional mouth-nose compartment inside the face mask. This compartment is also intended to fit snugly around the nose and mouth to reduce re-breathing of carbon dioxide and fogging of the mask lenses. The nose/mouth mask only protects the user's respiratory inlet and requires separate goggles to protect the eyes. As such, it is not suitable for general protection against chemical and biological warfare, but is often used in industry where light weight and convenience are important and the level of exposure risk is well-known in advance. The third type is the hood protection gear that is sealed around the user's neck. This hood can only be used as an active mask because of its large dead space and compliant walls that promote carbon dioxide retention if a pump or blower is not used. The fourth type is the hybrid double seal device. This mask has a nose-mouth compartment that fits the user's face snugly and an enclosing hood that is constructed with a visor and a membrane that is sealed around the user's neck. This type of gear provides a high protection ratio, but is only safe to use if the mouth-nose compartment is tightly sealed. If the seal is incomplete or breaks during head motion, speech or other maneuvers, carbon dioxide-rich exhaled gas escapes into the hood cavity. and is re-breathed during the subsequent inhalation. Such re-breathing may cause carbon dioxide build-up and suffocation.

Further classification of gas masks relates to the different user grouping. In this respect, there are two categories: 1. masks intended for active personnel such as emergency crews and military personnel and 2. masks intended for sedentary civilian population. There are differences in design and construction as well as in distribution strategy for the two subgroups. The masks for civilian population are usually distributed with only rough individual customization (ie., ‘large’, ‘medium’, ‘small’). They must be very simple to use with only minimal training (eg., a video tutoring film). Moreover, the system must be both effective and safe beyond doubt for the vast majority of people. Thus, it should provide adequate protection while being safe under multitude of circumstances. Safety criteria include upper threshold for inhaled carbon dioxide level (F₁CO₂) that must be less than 2% and a minimum value of inhaled oxygen (F₁O₂) that must be greater than 17%. These thresholds must not be violated for a period that is continuously longer than sixty seconds. The novel chemical-biological protection gear disclosed herewith is specifically intended for use by such untrained, diverse civilian populations.

Finally, a category of protective gear is defined by the placement and configuration of the inlet and outlet respiratory valves. In all gas masks the exhalation valve is located in direct communication with the mouth-nose compartment so that the exhaled gas can exit the system easily and promptly. The placement of the inhalation valve(s) varies among gas masks, but in most systems that have an inner mouth-nose compartment, there are two sets of inspiratory valves: 1) a valve leading from the filter into the cavity of the outer shell and 2) a valve or vales leading from the outer shell into the mouth-nose compartment. The advantage of this configuration is that fresh air flushes the interior of the outer shell with every breath. This is most useful in keeping moisture from condensing on the lenses or visor elements of the mask. The disadvantage of this arrangement is that exhaled gas that may escape under the seal from the mouth-nose compartment into the shell mixes with the fresh gas and causes partial re-breathing of a carbon dioxide-rich and oxygen-poor gas. Placement of the inhalation valve directly in communication with the mouth-nose compartment is found in industrial mouth-nose masks where independent goggles are used for eye protection. When used in a facemask variant that does not have a sealed mouth-nose compartment, the internal volume becomes too large (i.e., 500 ml.) creating an excessive respiratory dead space, which may be too large for persons with small lung capacity.

### BRIEF DESCRIPTION OF THE DRAWINGS

FIG. 1 is a schematic description of a prior art respiratory protective mask showing the elements forming the breathable air cavity.

FIG. 2A is a schematic description of a contact zone between the skin of the wearer and the sealing member of a protective mask;

FIG. 2B is an enlarged portion of the contact zone described in FIG. 2A.

FIG. 3A is a schematic isometric description of a multi-ridged surface of sealing member of the invention;

FIG. 3B is a schematic isometric description of a multi-ridged surface of sealing member of the invention with the tips of the ridges blunted by a cylinder;

FIG. 3C is a schematic isometric description of a multi-ridged surface of sealing member of the invention;

FIG. 3D is a schematic isometric description of a multi-ridged surface of sealing member showing grouped arrangement of blunted ridges;

FIG. 4 is a schematic description of an effect of the a bulge on a ridge;

FIG. 5 is a schematic description of a protective respiratory mask having a supplementary hood worn by a user.

FIG. 6 is a schematic description of a cross section in a breathable air cavity showing air passageways;

FIG. 7A is a schematic description of a cross section in an outlet passageway showing closed valve;

FIG. 7B is a schematic description of a cross section in an outlet passageway showing opened valve;

FIG. 8A is a schematic description of a cross section in an outlet passageway of the invention showing closed valves forming an air cavity;

FIG. 8B is a schematic description of a cross section in an outlet passageway of the invention showing opened valves.

### DETAILED DESCRIPTION OF THE PRESENT INVENTION

The present invention provides novel useful features for implementing in a protective face mask.

Aspect 1. Sealing members

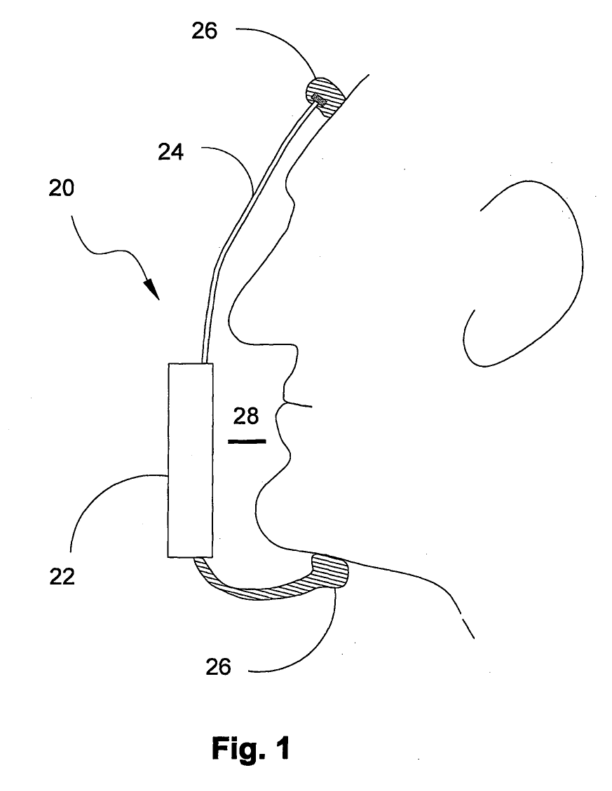

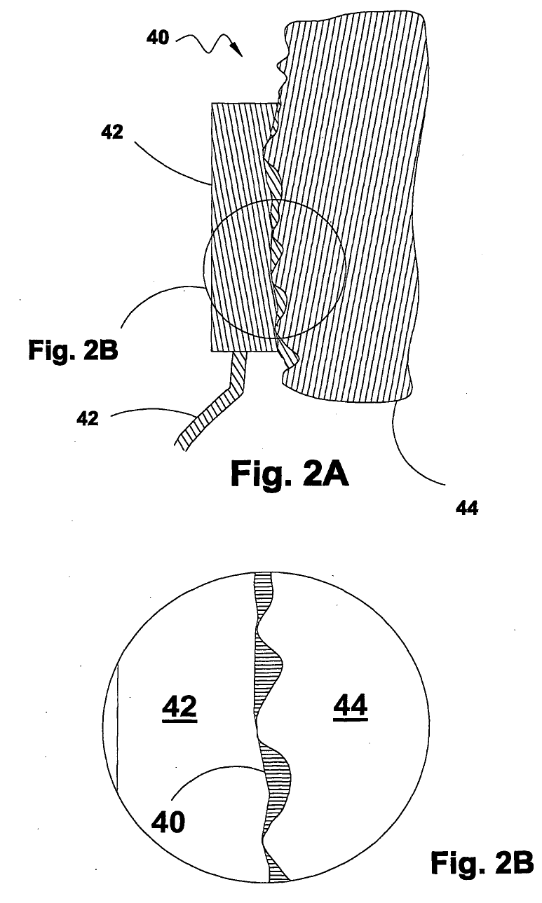

In a respiratory protective mask (RPM), sealing off a breathable air cavity (BAC) by pressing a rim of the mask against the skin, provides protection against contaminants contained in the ambient air. The contaminants in the air when entering the BAC through a suitable filtering means, thus providing clean air to the respiratory system. A sealing member is typically disposed at the rim of the mask to be laid against the skin of the wearer. In FIG. 1 to which reference is now made, a cross sectional view through a worn RPM 20 is shown, showing in very general terms some of its structural aspects. An air filtering means 22 constitutes a part of the mask which contains in addition a visor 24 and sealing members 26. Elements of the mask and the face of the wearer define a BAC 28 and seclude it from the ambient air. The seclusion takes effect through the tight juxtaposition of a sealing member against the skin. Some RPMs, such as disclosed in U.S. application Ser. No. 60/415,465 by the inventor of the present invention contain several compartments which must be secluded from each other. This seclusion also takes effect through the tight juxtaposition of a sealing member against the skin. The skin however, is not a smooth, flawless surface, and the level of roughness of the skin varies considerably from place to place and among different individuals. Various creases, bulges, hair and other micro-structural irregularities as well as traumatized portions of the skin pose obstructions to effective sealing. This is described schematically in FIG. 2A to which reference is now made. The skin-seal junction 40 is a meeting place of the seal 42 and a portion of the skin 44. Bumps and creases 46 on the skin surface cause an imperfect adherence of the skin 44 to the sealing member 42. The sealing member forms a part of the body of the mask such as to mask member 48, in such a way as to form a continuum surrounded by a sealing member. In FIG. 2B to which reference is now made, an enlarged portion of the skin seal junction is shown, indicating schematically incompleteness of the sealing of the mask to the skin.

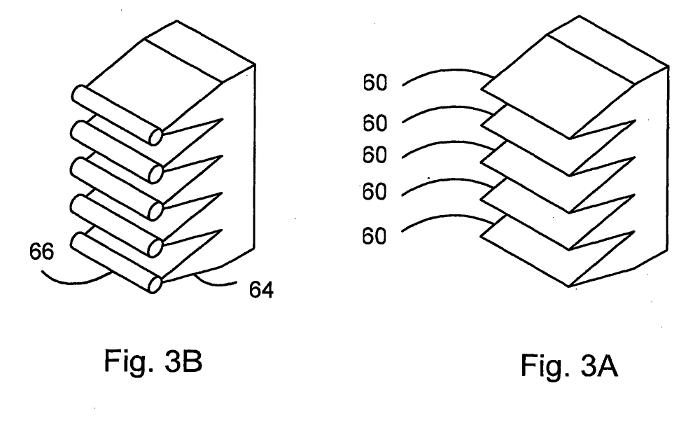

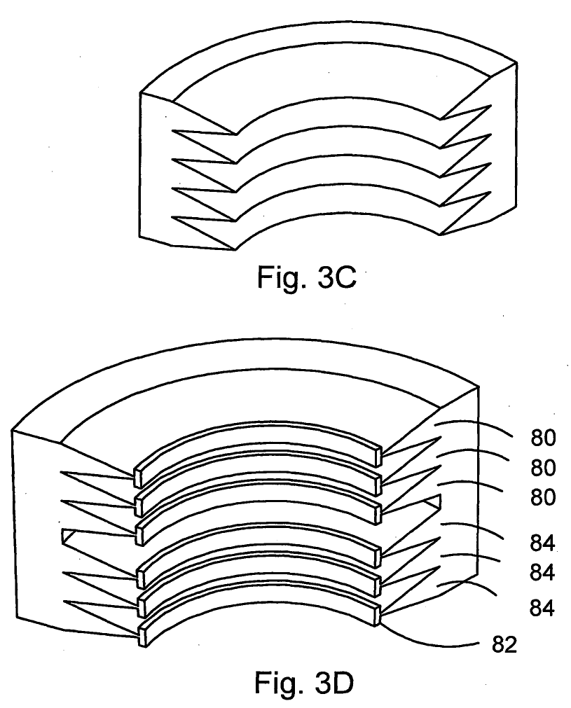

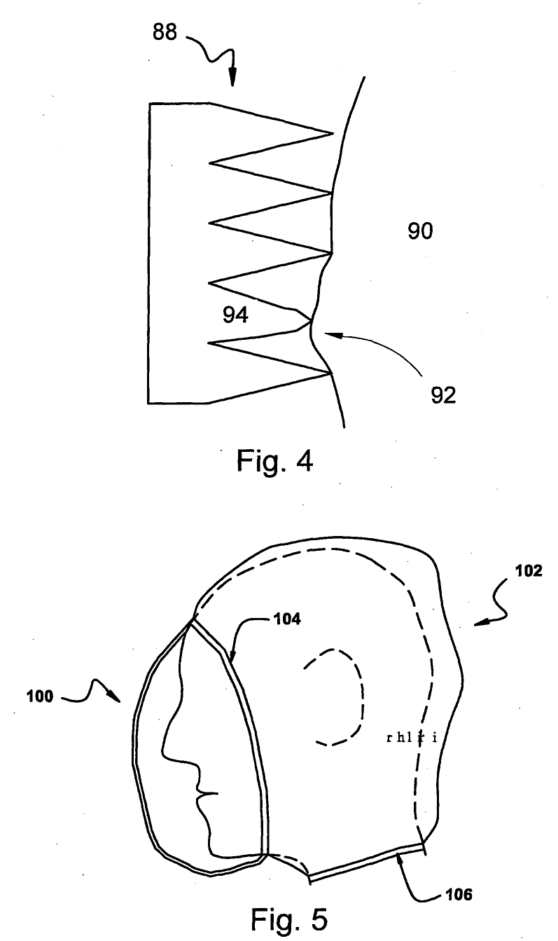

A sealing member in accordance with the present invention has a multi-ridged contact facet facing the skin-seal junction as described further with reference to FIGS. 3A-D. The multi-ridged contact facet contacts the skin and bears the pressure exerted by the mask. In FIG. 3A, a section of a sealing member in accordance with the present invention is shown. Ridges 60 protrude in the direction of the skin (not shown). In FIG. 3B the section of a sealing member is shown, wherein the protruding ridges such as ridge 64 have a rounded tip in the form of a cylinder such as cylinder 66. The added cylinder increases the contact area of each ridge with the skin locally. The sealing member has sufficient flexibility to adapt to contours of the skin of the wearer, as can be seen in FIG. 3C. In FIG. 3D several additional optional features of the sealing member of the invention are described. First, the ridges in this embodiment are blunted by an attached railing member such as railing member 70. Another feature of this embodiment is the distribution of ridges in groups. The ridges 80 are all contiguous, belonging to one group. Ridges 82 are contiguous, belonging to another group. The grouping and sculpturing of the ridges are meant to effectively distribute the pressure and contact area of the sealing member with the skin in order to improve the sealing of the mask against the skin. FIG. 4 to which reference is now made, is a cross sectional view of the seal 88-skin portion 90 junction. Skin bulge 92 pushes against ridge 94, thereby changing its configuration. The other ridges are not affected.

To summarize the variability of this aspect of the invention, the following list of parameters of the ridges can be considered as liable to a designer's quantitative judgment. The length in the direction perpendicular to the skin, the width at the base, type of blunting member, tapering in the direction perpendicular to the skin, the number of ridges, number of groups of ridges, and the uniformity over the entire mask. It is possible in accordance with the present invention, to employ different design parameters to the sealing member at different sites in the mask.

Aspect 2. Speaking diaphragms

Since the RPM muffles the voice of the wearer, a speech diaphragm is usually applied at a port of the mask, typically near the mouth. The speaking diaphragm of the art are typically disc-shaped, having thus a radial symmetry. An implication of the radial symmetry of the speaking diaphragm is the specific natural frequency which it has, which determines a corresponding resonance frequency. This frequency depends on the radius, distribution of mass, bending stiffness and tension of the diaphragm. The single resonance of such a round diaphragm, is a cause of corrupted audible effect, such as distorting the voice of the wearer.

In accordance with the invention, a non-radial speaking diaphragm is provided, the geometry of which specifies more than one resonance. Typically the shape of the speaking diaphragm of the invention is oval or ellipsoidal.

Aspect 3. Heat exchanging hood

Some RPMs include a protective hood worn on the head. Such is the protective mask disclosed in U.S. application Ser. No. 60/415,465 by the inventor of the present invention. In FIG. 5 to which reference is now made, BAC 100 is extended to the rear, forming a hood 102 covering the head and parts of the neck. The hood is sealed by sealing members 104 and 106. Applying the hood over one's head and using it for extended periods of time is potentially a bothersome task, irritating the skin, hair and specifically the scalp. Build-up of humidity and of temperature in the volume enclosed by the hood may be swift and annoying.

In accordance with the present invention the hood is made from a fabric having a high air and moisture permeability yet protects against chemical agents. Such is the garment “Safeguard 2002™—HP” made by Alfred Kärcher GmbH & Co. of Alfred Kärcher Str. 28-40, D-71364 Winnenden—Germany. This garment is made of two layers, the outer layer is made of impregnated cotton, and the inner layer made of a flame retardant non woven fabric containing activated carbon. The hood in accordance with the invention is therefore permeable to air and humidity to some extent. The wearer can relieve the stress caused by the hood, by inflating and deflating it by pulling out the garment then squeezing back. This inflating-squeezing action refreshes the air locked inside the hood, dehumidifies by driving out hot humid air, bringing in fresher air. The air movement by itself can bring about a relief in the heat/humidity stress.

Aspect 4. Multi-stage valve assembly

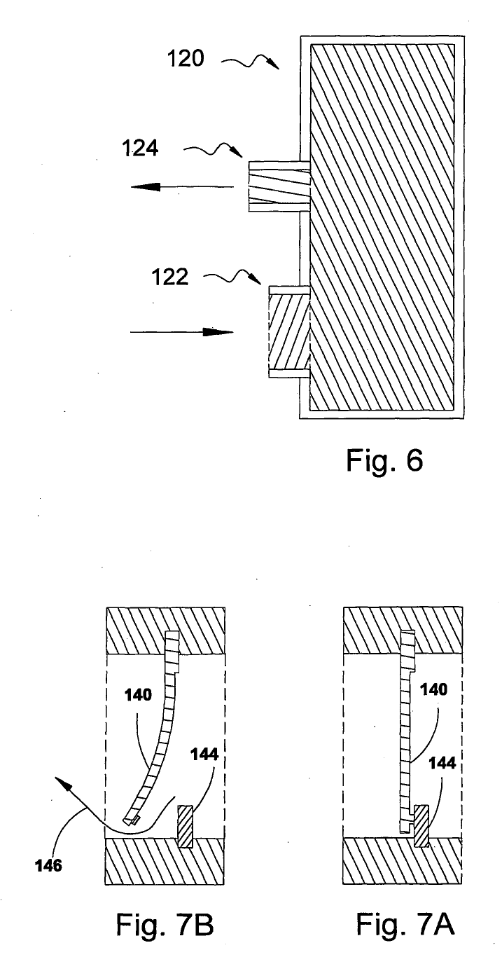

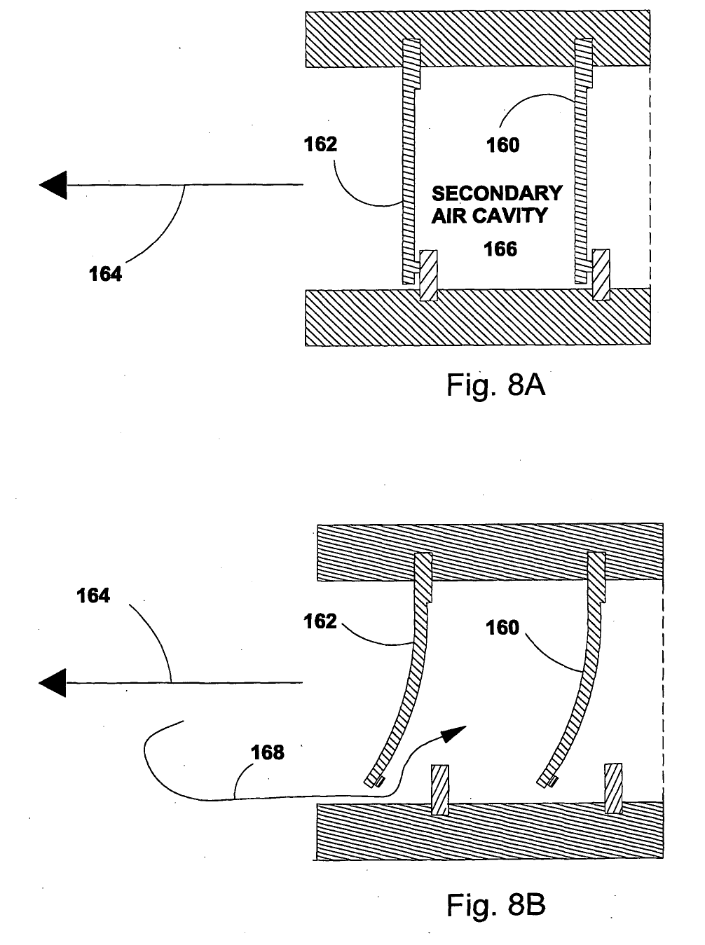

In the BAC of any face mask, air is shifted in or out through at least three passageways, a first passageway is the wearer's respiratory system passageway, nose or mouth, a second passage way is the air filter's inlet port, and the third passageway is the outlet valve. The third passageway is associated with the removal of air from the BAC. In FIG. 6 to which reference is now made, the BAC 120 is shown schematically, having the air filter passageway 122 allowing air inside. The other passageway shown schematically is the outlet valve 124. The outlet valve permits air to exit the BAC, as long as internal pressure prevails. As soon as the wearer stops exhaling, the outlet valve shuts down, preventing external air from entering the BAC air cavity. However, during the closing motion of the valve, a minute amount of contaminated ambient air may enter the BAC, creating a risk of exposure. This is explained with reference to FIG. 7A-B. In FIG. 7A one way valve 140 presses against seal projection 144 as long as no supra atmospheric internal pressure is applied. External ambient air is secluded from the BAC at the right hand side of the valve. When internal pressure is applied in the BAC, as shown in FIG. 7B, one way valve 140 deflects towards the left side, separating from the seal projection 144, letting air out in the direction indicated by arrow 146. In accordance with the invention, a secondary air cavity is provided at the outlet passageway, for keeping out residual amount of external air, which may penetrate the BAC through the outlet passageway. This can be achieved by adding at least one more one-way-valve in series along the path of the air going out from the BAC. This is described schematically in FIGS. 8A-B to which reference is now made. In FIG. 8A two one way valves 160 and 162 are disposed serially. Outgoing air can flow in the direction of arrow 164 when the valves are opened. When the two valves are closed, as shown in the figure, a secondary air cavity 166 is formed, sealed from all sides. In FIG. 8B the situation described schematically is such that the two one-way-valves are opening the passageway for outgoing air. Although the general direction of air flowing is in the direction of arrow 164, due to the turbulence of the air flow, some portion of the external ambient air may leak back, eventually reaching the BAC as indicated schematically by arrow 168. The secondary cavity formed between the two (or more) valves retains the majority of the leaked air when internal pressure drops, as can be seen in FIG. 8A.

It should be pointed out that the form of valves indicated in the drawings heretofore described are taken as representing any type of valves suitable for restricting the movement of air unidirectionally. In addition more than two valves can be utilized for the same end, provided they are all aligned in the outward direction of air flow.

1. A respiratory protective mask wherein at least one sealing member is employed in sealing off at least a breathable air cavity, and wherein said sealing member has a contact facet facing the skin of the wearer, said contact facet comprising a multiplicity of protruding ridges.

2. A respiratory protective mask as in claim 1 and wherein said at least one sealing member is employed for sealing off compartments within said mask.

3. A hood for protecting a wearer of a respiratory protective mask, wherein said hood is made of garment permeable to air and humidity and wherein said garment comprises a component for providing protection against at least a chemical agent.

4. A multi-stage valve assembly for blocking intake of ambient outside air into a breathable air cavity formed between a respiratory air mask and the wearer, said assembly comprising:
at least two one-way-valves disposed serially in the direction of outgoing air, and
at least one cavity formed between at least two one-way-valves for blocking a residual amount of ambient air.

5. A respiratory protective mask comprising a speaking diaphragm and wherein the shape of said speaking diaphragm is other than round.
